(19) United States
(12) Patent Application Publication
(10) Pub. No.: US 2003/0127562 A1
(43) Pub. Date: Jul. 10, 2003

(54) Security partition system for prevention of hijackings

(76) Inventors: Edson J. Pereira, Somerville, MA (US); Fauston J. Pereira, Malden, MA (US)

Correspondence Address: LAMBERT & ASSOCIATES, P.L.L.C., 92 STATE STREET, BOSTON, MA, 02109-2004, US

(21) Appl. No.: 10/041,050

(22) Filed: Jan. 7, 2002

(51) Int. Cl. B64D 11/00; B64D 13/00

(52) U.S. Cl. 244/118.5

(57) ABSTRACT

A security partition system for prevention of hijackings on airplanes having a plurality of primary partition housings and a plurality of primary partition units. The primary partition units are stored above the passenger seats and, upon activation, the primary partition units slide out of primary partition housings and create a wall between the seat rows and the aisle of the plane thus confining potential hijackers inside of the aisles. A plurality of secondary partition units could be added to isolate individual rows of seats by coupling secondary partition units to seats and the ceilings above the seats.

### FIELD OF THE INVENTION

This invention relates to systems designed to prevent hijackings of airplanes. In the past, a variety of systems were disclosed which aim to prevent airplane hijackings. One such system was disclosed by Anderson, U.S. Pat. No. 3,658,277, where a trap chamber is built into a plane in an area separating the cockpit and the passenger compartment. The trap chamber is used to contain any hijackers who would try to gain access to the cockpit of the airplane. Another system was disclosed by Boudreau, U.S. Pat. No. 3,680,499, where a phone system is built into the airplane for communication between any potential hijacker and a pilot. While the hijacker attempts to issue demands to the pilot over the phone, the pilot can activate a release of disabling gas from the phone held by the hijacker thus disabling the hijacker. Ord, U.S. Pat. No. 3,704,845, discloses a system where the door to the cockpit is reinforced and the communication system allows for pilots to converse with hijackers while only allowing hijackers a very limited scope of signals that could be communicated back to the pilots. Thus, hijacker can issue no demands such as commanding for an alternative destination of a flight while allowing pilots to safely land the plane. Garehine Jr., U.S. Pat. No. 4,112,818, discloses an aggressive system where a hidden movable camera coupled with a gun monitors the passenger cabin and allows an operator in a cockpit to observe passenger area and, if needed, fire the gun at a hijacker. Yet another anti-hijacking device disclosed by Pizzo, U.S. Pat. No. 3,811,643, has trapdoors located in an area leading to the cockpit. A hijacker attempting to gain entry into the cockpit would be dropped by the trapdoor into a bag located in the baggage compartment of the plane and bomb bay doors would open to drop the hijacker in a bag out of the plane. The bag containing the hijacker would have a parachute to safely bring the hijacker back to the ground.

However, none of these systems disclose an ability to capture hijackers within the confines of the rows of seats in the passenger compartment of the airplane. Since quite often hijackers, are seated at various sections of the plane, it is desirable to isolate all passenger seats. What is a needed is a simple and inexpensively manufactured system that would allow confining of all the hijackers within the individual seat rows thus preventing them from gaining access to the cockpit and from inflicting harm on the passengers.

### SUMMARY OF THE INVENTION

The present invention represents a security partition system designed to prevent hijackings of airplanes. The main feature of the invention is in isolating rows of passenger seats from an aisle of the airplane. The rows are isolated from the aisle by deployment of a single primary partition unit or a plurality of primary partition units. Each primary partition unit is stored in a partition housing located above the passenger seats, and preferably under the overhead storage bins. A control member, is located inside of the cockpit. After the passengers boarded the plane, the primary partition units are deployed from the partition housings and create a wall between the passenger seats and the aisle. Thus, the hijackers, if there are any among the passengers, are confined and cannot gain access to the aisle and the cockpit. In addition, secondary partition units could be installed to separate seat rows. Each secondary partition unit is coupled to a passenger seat and the ceiling above the passenger seat. Thus, hijackers would be confined within the individual rows of seats. When some passenger express a desire to go to a restroom, a flight attendant could either raise the partition or signal the pilot to activate the means for lifting of the partition, which isolates the row in which the passenger who wishes to leave his seat is located. When the plane lands, all partition units could be raised to allow passengers to leave the plane.

In another embodiment, the primary partition unit is slidably mounted on a railing device. By sliding on the railing, the primary partition unit can move from an overhead area above the seats to a side of the seat rows thus blocking them from the aisle.

In addition, disclosed partitions could be used to afford greater privacy for the passengers.

Therefore, it is the object of the present invention to provide a security partition system that would prevent hijackings of airplanes.

It is another object of the present invention to provide a security partition system that would deter hijackings of airplanes.

It is yet another object of the present invention to provide a security partition system that could also be used to create greater degree of privacy for passengers.

### BRIEF DESCRIPTION OF DRAWINGS

These and other features, aspects and advantages of the present invention will become better understood with reference to the following description, appended claims, and accompanying drawings where:

FIG. 1 is a prospective view of one of the embodiments of the part of the invention showing a partition housing and a primary partition plate in a contained configuration.

FIG. 2 is a prospective view of one of the embodiments of the part of the invention showing the partition housing and the primary partition unit in a transitional position between the contained and deployed configurations.

FIG. 3 is another perspective view of one of the embodiments of the part of the invention showing the primary partition housing and the primary partition unit in a transitional position between the contained and deployed configurations.

FIG. 4 is a side view of one of the embodiments of the part of the invention showing the primary partition housing and the primary partition unit in a transitional position between the contained and deployed configurations.

FIG. 5 is a perspective view of one of the embodiments of the invention showing the primary partition unit in a deployed configuration.

FIG. 6 is perspective view of one of the embodiments of the invention showing a cutout of an airplane passenger compartment with a plurality of primary partition units in a deployed configuration.

FIG. 7 is a perspective view of one of the embodiments of the invention showing the primary partition unit in a contained configuration.

FIG. 8 is a perspective view of one of the embodiments of the invention showing the primary partition unit in a deployed configuration.

FIG. 9 is a perspective view of one of the embodiments of the invention showing a secondary partition unit.

### DESCRIPTION OF THE INVENTION

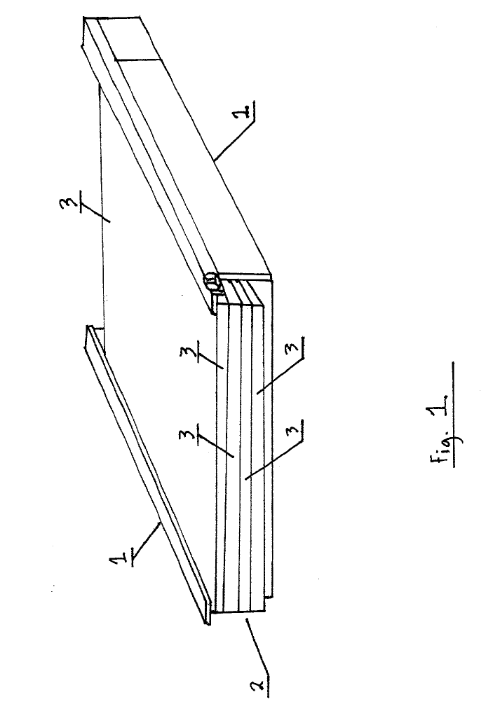

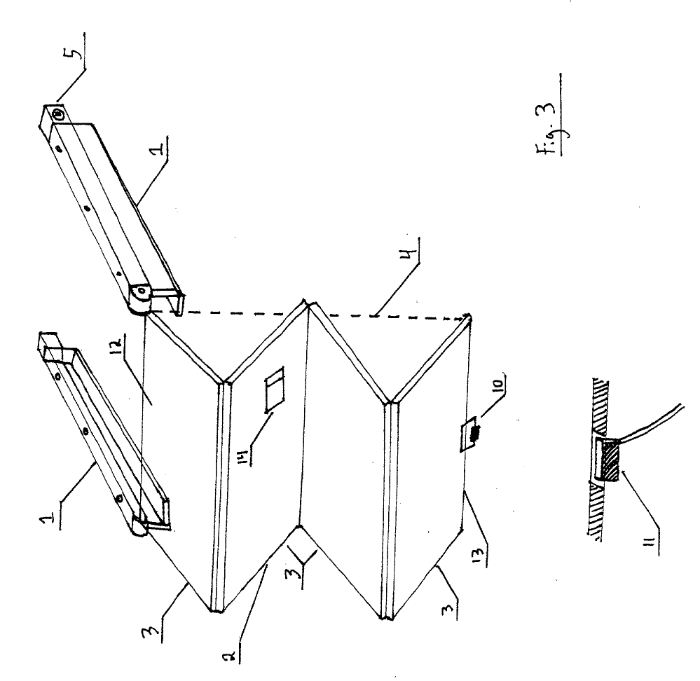

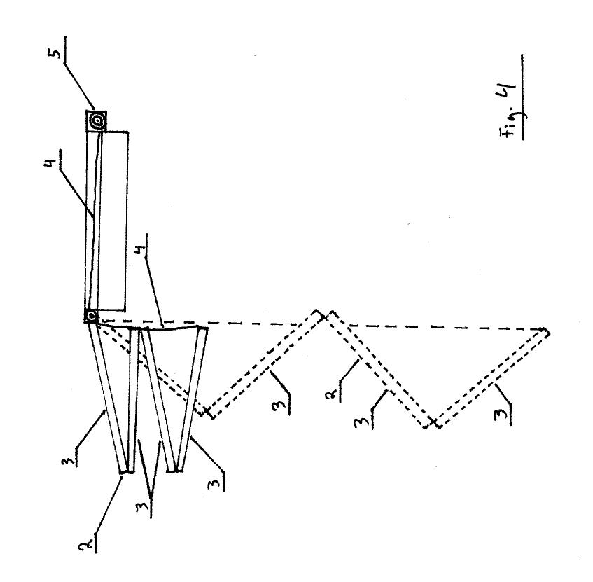

This invention represents a security partition system designed to prevent hijackings of airplanes. The system operates on an idea of isolating rows of seats from the aisle of the plane thus confining hijackers before they could gain access to the aisle and a cockpit. The isolation of the rows of seats from an aisle is accomplished through deployment of primary partition units 2 depicted in FIGS. 1-8. The primary partition unit 2 has a top end 12 and a bottom end 13 depicted in FIG. 3. The primary partition unit 2 could be composed out of a plurality of primary partition plates 3 coupled to each other and could have a slot door 14 depicted in FIG. 3. The slot door 14 is used to create an opening, a slot, for transferring of food, magazines, and other items, which flight attendants could pass to passengers in those rows which do not have confined hijackers.

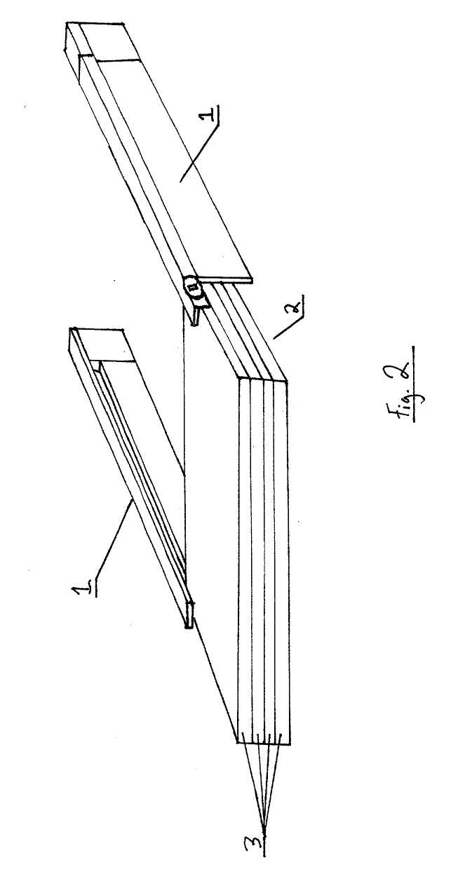

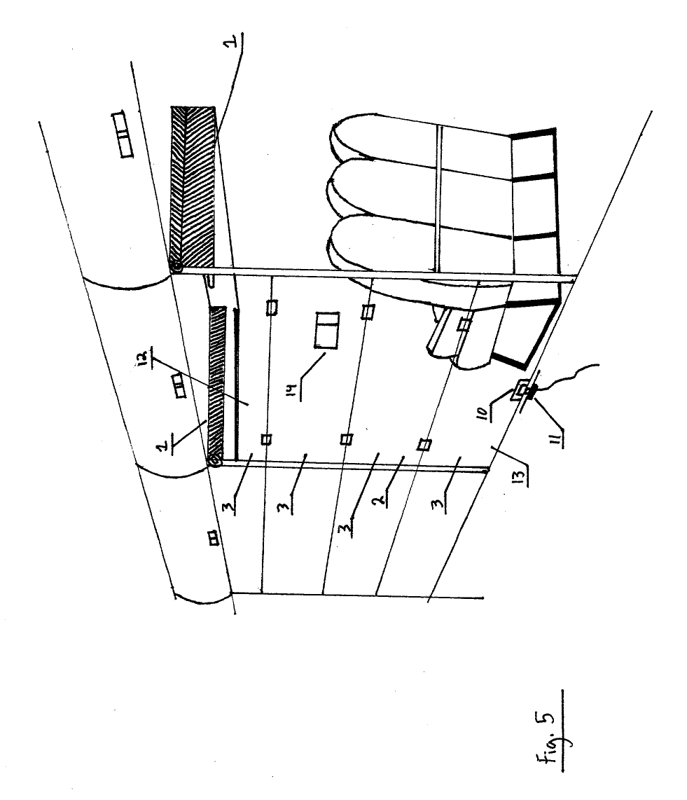

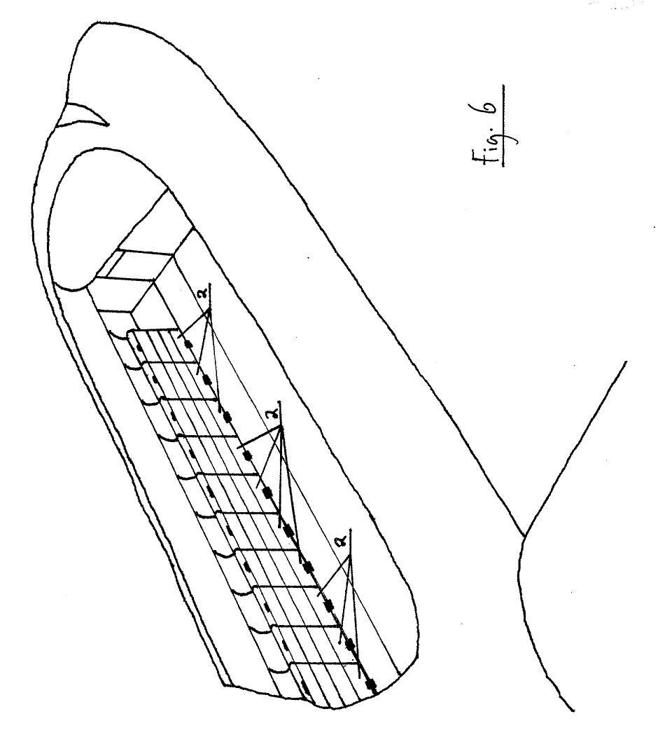

The primary partition unit 2 has two configurations, a contained configuration depicted in FIGS. 1 & 7, and a deployed configuration depicted in FIGS. 5, 6 & 8. In a contained configuration, the primary partition unit 2 is stored inside of the partition housing 1. To keep the primary partition unit 2 inside of the partition housing 1, a well known in the art means are used such as a cable 4 coupled at one end to the bottom end 13 of the primary partition unit 2 with the other end of the cable 4 coupled to and wrapped around a winch 5 housed inside of the partition housing 1. When the cable 4 is retrieved onto the winch 5, through a motor driving the winch 5, the primary partition unit 2 is retained inside of the partition housing 1 (the motor is not depicted in drawings and could be any well known in the art motor). The primary partition housing 1 is mounted at an angle so as to allow the primary partition unit 2 to transform by action of gravity into a deployed configuration upon release of the cable 4 from the winch 5 through action of a motor. The primary partition unit 2 would start sliding out of the primary partition housing 1 as depicted in FIGS. 2-4. However, other means well known in the art could be used to deploy the primary partition unit 2.

When the primary partition unit 2 assumes the deployed configuration, a locking extension 10 present on the bottom end 13 of the primary partition unit 2 engages a lock 11 positioned on the floor of the passenger cabin thus locking the primary partition unit 2 in a deployed configuration. Similarly, other well known in the art means could be used to lock the primary partition unit 2 in a deployed configuration.

The initiation of the security partition system is done by a pilot who would activate the control member 30 before take off, as shown in FIG. 6. The control of the primary partition unit 2 through the control member 30 is accomplished through means well known in the art such as an emitter and receiver system or an electric circuit control system.

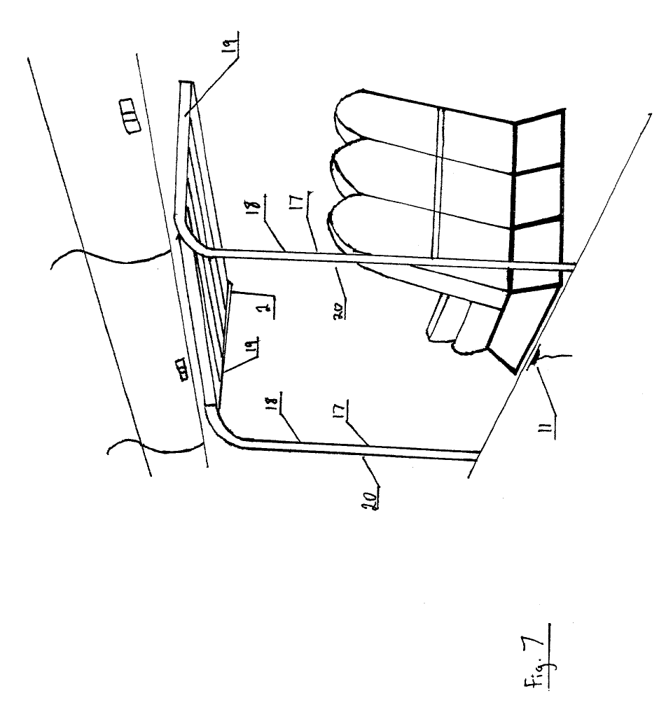

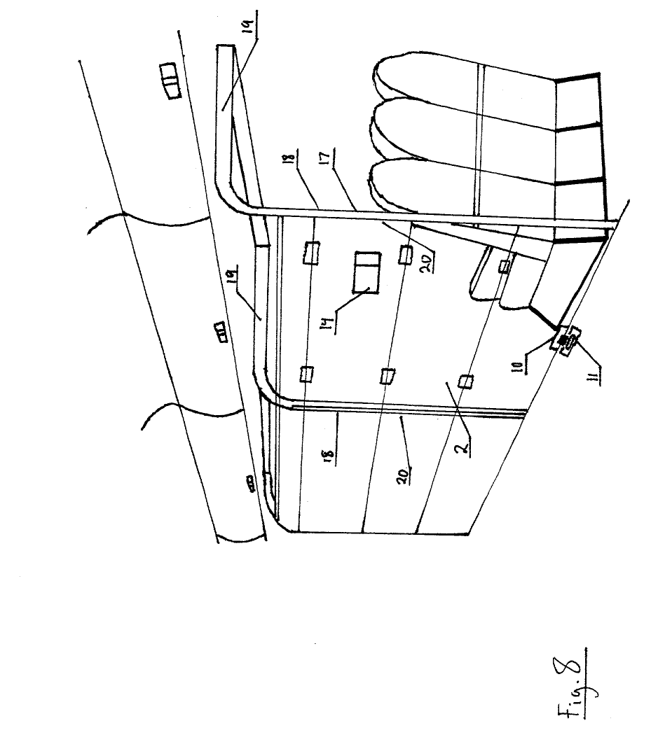

In another embodiment of the invention, the partition housing 1 is replaced with a railing device 17 depicted in FIGS. 7 & 8. The railing device 17 is composed of at least two rail members 18 upon which the primary partition unit 2 is slidably mounted. The railing device 17 has a top portion 19 positioned above the passenger seats and a side portion 20 positioned laterally to a section of passenger seats and has a substantially vertical orientation. Through means well known in the art the primary partition unit 1 slides from the contained configuration depicted in FIG. 7 to a deployed configuration depicted in FIG. 8.

### DESCRIPTION OF THE PREFERRED EMBODIMENT

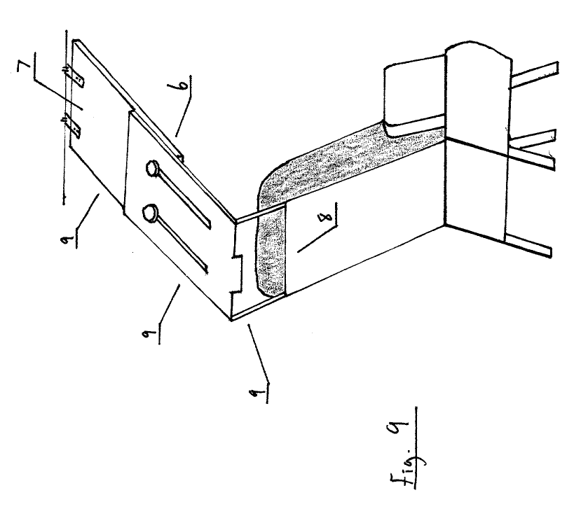

In a preferred embodiment, there also exists a plurality of secondary partition units 6 depicted in FIG. 9. Each secondary partition unit 6 has a top end 7 coupled to a ceiling above the seat and a bottom end 8 coupled to a seat. Each secondary partition unit 6 could be composed of a plurality of secondary partition plates 9 coupled to each other. Some of the secondary partition plates 9 could be slidably mounted to each other in order to accommodate for the adjustment of positioning of the back of the seat. Existence of the secondary partition units 6 further isolates hijackers within the seat rows or alternatively provides increased privacy for the passengers. Meanwhile, each primary partition unit 2 isolates one flank of one row of passenger seats.

Additionally, in a preferred embodiment, the primary partition units 2 and secondary partition units 6 are made out of a transparent and bulletproof material. Thus, flight attendants could observe the passengers from behind the primary partition units 2. Having bulletproof material prevents any potential hijackers from being able to harm flight attendants or passenger in other rows of seats.

What is claimed is:

1. A security partition system for passenger airplanes comprising:
at least one partition housing, located at an elevation with respect to passenger seats of an airplane;
at least one slidably mounted primary partition unit, having a top end and a bottom end, and having a contained configuration and a deployed configuration, wherein in the contained configuration the primary partition unit is stored in the partition housing, and wherein in the deployed configuration the primary partition unit isolates a section of passenger seats from an aisle of the airplane;
means for deploying the primary partition unit from the partition housing, thereby transforming the primary partition unit from the contained configuration to the deployed configuration;
means for actuating means for deploying the primary partition unit from the partition housing.

2. The security partition system for passenger airplanes of claim 1 further comprising:
means for retrieving the primary partition unit into the partition housing, thereby transforming the primary partition unit from the deployed configuration to the contained configuration.

3. The security partition system for passenger airplanes of claim 1 further comprising:
means for actuating means for retrieving the primary partition unit into the partition housing.

4. The security partition system for passenger airplanes of claim 1 further comprising:
means for locking the primary partition unit in the contained configuration.

5. The security partition system for passenger airplanes of claim 1 further comprising:
means for locking the primary partition unit in the deployed configuration.

6. The security partition system for passenger airplanes of claim 1 further comprising:
at least one secondary partition unit, having a top end and a bottom end, wherein the top end is coupled to a section of a plane ceiling positioned above a passenger seat and the bottom end is coupled to a passenger seat.

7. The security partition system for passenger airplanes of claim 6 wherein:
the secondary partition unit is comprised of at least two secondary partition plates coupled to each other.

8. The security partition system for passenger airplanes of claim 1 wherein:
the primary partition unit is composed of a plurality of coupled primary partition plates.

9. The security partition system for passenger airplanes of claim 1 wherein:
the primary partition unit has a slot and a slot door, wherein the slot door has means for locking and unlocking the slot door by a person located in the aisle of the airplane.

10. The security partition system for passenger airplanes of claim 1 further comprising:
a control member located in a cockpit of the airplane, having means for operation of the security partition system.

11. A security partition system for passenger airplanes comprising:
at least one railing device, having at least two rail members, and having a top portion and a side portion, wherein the top portion is positioned above a section of passenger seats, and the side portion is positioned laterally to a section of passenger seats and has a substantially vertical orientation.
at least one partition unit, slidably mounted on at least one railing device, having a top end and a bottom end, and having a contained configuration and a deployed configuration, wherein in the contained configuration the primary partition unit is mounted on the top portion of the railing device, and wherein in the deployed configuration the primary partition unit is mounted on the side portion of the railing device;
means for sliding the primary partition unit from the top portion of the railing device to the side portion of the railing device, thereby transforming the primary partition unit from the contained configuration to the deployed configuration;
means for actuating means for sliding the primary partition unit from the top portion of the railing device to the side portion of the railing device, thereby triggering transformation of the primary partition unit from the contained configuration to the deployed configuration.

12. The security partition system for passenger airplanes of claim 11 further comprising:
means for sliding the primary partition unit into the top portion of the railing device from the side portion of the railing device, thereby transforming the primary partition unit from the deployed configuration to the contained configuration;

13. The security partition system for passenger airplanes of claim 11 further comprising:
means for actuating means for sliding the primary partition unit into the top portion of the railing device from the side portion of the railing device, thereby triggering transformation of the primary partition unit from the deployed configuration to the contained configuration.

14. The security partition system for passenger airplanes of claim 11 further comprising:
means for locking the primary partition unit in the contained configuration.

15. The security partition system for passenger airplanes of claim 11 further comprising:
means for locking the primary partition unit in the deployed configuration.

16. The security partition system for passenger airplanes of claim 1 further comprising:
at least one secondary partition unit, having a top end and a bottom end, wherein the top end is coupled to a section of a plane ceiling positioned above a passenger seat and the bottom end is coupled to a passenger seat.

17. The security partition system for passenger airplanes of claim 16 wherein:
the secondary partition unit is comprised of at least two secondary partition plates coupled to each other.

18. The security partition system for passenger airplanes of claim 111 wherein:
the primary partition unit is composed of a plurality of coupled primary partition plates.

19. The security partition system for passenger airplanes of claim 11 wherein:
the primary partition unit has a slot and a slot door, wherein the slot door has means for locking and unlocking the slot door by a person located in the aisle of the airplane.

20. The security partition system for passenger airplanes of claim 11 further comprising:
a control member located in a cockpit of the airplane, having means for operation of the security partition system.
